(19) United States
(12) Patent Application Publication
(10) Pub. No.: US 2017/0180611 A1
(43) Pub. Date: Jun. 22, 2017

(54) Method and Apparatus to Capture Continuous High Resolution Images of Moving Train Car Undercarriage and its Structural Components

(71) Applicants: Gianni ARCAINI, Jacksonville, FL (US); William Scott CARNS, Jacksonville, FL (US); Charles HOEPPNER, Jacksonville, FL (US); Israel UMBEHANT, Jacksonville, FL (US)

(72) Inventors: Gianni ARCAINI, Jacksonville, FL (US); William Scott CARNS, Jacksonville, FL (US); Charles HOEPPNER, Jacksonville, FL (US); Israel UMBEHANT, Jacksonville, FL (US)

(21) Appl. No.: 14/971,145

(22) Filed: Dec. 16, 2015

(51) Int. Cl. H04N 5/225; H04N 5/232; H04N 5/235; B60R 1/00; H04N 5/04

(52) U.S. Cl. CPC H04N 5/2252; B60R 1/00; H04N 5/04; H04N 5/2254; H04N 5/2351; H04N 5/23203; H04N 5/23293

(57) ABSTRACT

A container that will house components of the device will be mounted to railroad ties to permit the user of this device to gather high resolution images of the undercarriage of a moving train car as it passes overhead. The speed of the camera shutter will be dictated by the software that will work in conjunction with a linear speed device. The gathered images can be reassembled and forwarded to a remote location. The software provides an alarm in the event of a present danger.

### BACKGROUND OF THE INVENTION

A. Field of the Invention

This relates to railroad inspection and specifically the inspection of the undercarriage of a moving train.

As trains are typically located in remote areas, it is important at times to be able to visually inspect and communicate the inspection of the integrity of a train and its components to remote locations. This device is a device that is placed on the railroad ties between the railroad tracks. As a train moves along the railroad tracks, the device will capture high resolution images of the undercarriage of the moving train. The images can then be transferred to remote locations to detect the presence of anomalies that would then result in appropriate remedial action.

Prior Art

Currently, in order to inspect the undercarriage of a train the train must be stopped and visually inspected by personnel.

This invention is intended to replace the procedure of slowing or stopping a train while a team of security personnel physically search and inspect for potential hazards on the train. The process of stopping a train costs significantly more time and resources than the presented invention. This invention records a series of digital images that are transmitted to a remote location for viewing by an individual or a computer.

There are other prior art references that teach the undercarriage inspection systems. Specifically, a representative example is U.S. Pat. No. 6,856,344 by Frantz is an image inspection system of vehicle undercarriages of cars. Although this invention may be useful for monitoring vehicles, it does not teach a use for inspecting train undercarriages.

### BRIEF DESCRIPTION OF THE INVENTION

On the undercarriage of a train it is important to be able to detect any anomalies such as foreign objects that may be lodged in the undercarriage as well as check the integrity of the hasps, knuckles, bolt plate, bolts and sill on the undercarriage of the train. A defect in the hasp, knuckle or bolt plate may cause the train to derail. Similarly a foreign object on the undercarriage should be detected as soon as possible so that remedial action can be taken, if needed.

The device itself houses several components including the following: camera, mirror, lighting, anti-glare glass and a slit through which the images are taken. The components of the device are placed in a container that is secured between the railroad ties. The placement of the container that houses the components is designed to prevent harm to the components. It may be mounted to the railroad ties or buried depending on the desires of the customer.

Images from a high speed camera that is located in the container beneath the train will take a multitude of pictures that are transmitted to a separate server. Because trains are moving at relatively rapid speeds it is important to initially accurately measure the speed of the train in order to establish the rate at which the camera should takes photos of the train's undercarriage.

A linear speed detection device is utilized to measure the speed of the train within a percentage of a mile per hour. The speed of the train is first measured by a series of speed indicators that are located on the tracks that will provide a precise measurement of the speed of a train. This measurement is critical in order to set the frame rate of the camera that will take the pictures.

The system is turned on or “activated” as the train passes over a certain point on the track relative to the container that houses the components of the system. Although a variety of means may be used it is likely to be through use of a laser system that is mounted in close proximity to the railroad tracks and the components of the system.

This application works in close conjunction with a device that will detect the linear speed of the train to within a fraction of a second so that the appropriate camera frame speed can be adjusted using software for that purpose.

As the train rolls on the tracks, it will roll over the slit, which is approximately three pixels wide. Images will be continuously taken of the train's undercarriage at very high speeds using the camera that has been installed for that purpose. The speed at which images are taken directly correlates with the speed of the train which is provided by the linear speed device.

The camera is positioned so that the image is taken by deflecting the image off a mirror. This helps to insure that a proper image resolution and quality can be achieved while also preventing damage to the internal components of the device.

As the images are collected, the series of photographs are collected in fragmented pieces and then reassembled in the image of a preset image, likely a train car. Each of the collections of “train cars” are reassembled into a complete train.

In order to insure that the quality of the picture is not affected, a means of lighting is also provided. The means of lighting can be controlled both in terms of the intensity of the light as well as the direction of the light to obtain the best possible image of the undercarriage.

Anti-glare glass is also provided above the slit through which the image is taken to maximize the quality of the image. Trains operate in a multitude of operating conditions and the camera and all associated equipment must be able to operate in a multitude of lighting scenarios. Although no specific type of camera is contemplated, various types of cameras would include infrared cameras.

The device is also designed to be portable and can be positioned in different locations in the yard depending on the needs of the customer.

Software is included that will initially set the speed of the camera and operate the camera, using the associated linear speed detection device. The software will also permit the image to be reassembled and then transmitted to a remote location.

The software will also control the lighting around the area so that the best possible image may be taken to prevent shadows, among other environmental factors.

### BRIEF DESCRIPTION OF THE DRAWINGS

FIG. 1 is a view of the components of this device within the container.

FIG. 2 is a representation of the container mounted on the railroad ties.

FIG. 3 is a representation of the device as a train rolls over the device.

FIG. 4 is a schematic of the components of the device.

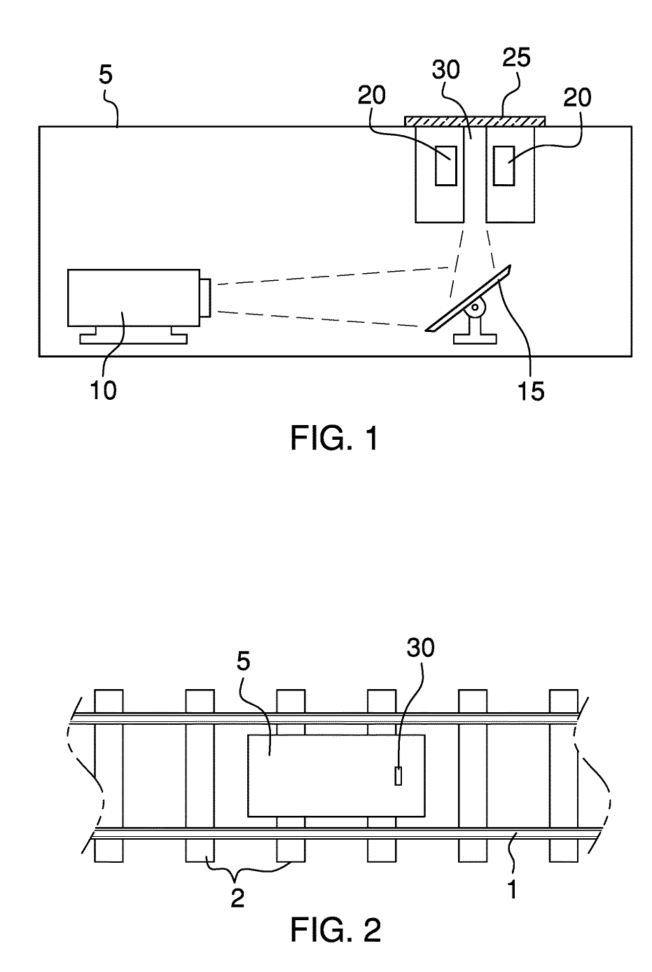

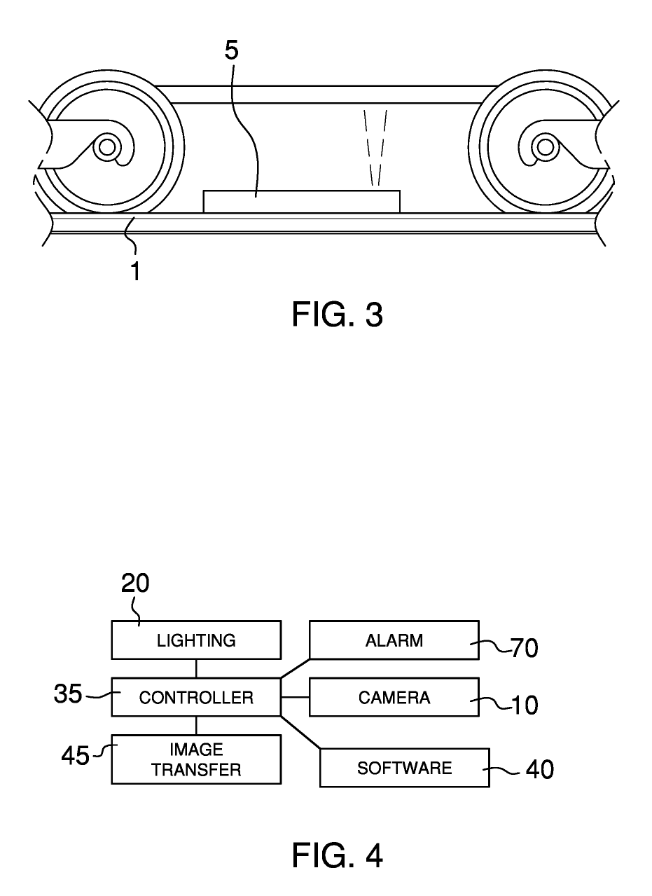

### NUMBERING REFERENCE

1 Railroad tracks
2 Railroad ties
5 Container
10 Camera
15 Mirror
20 Means of lighting
25 Anti-glare glass
30 Slit
35 Controller
40 Software
45 Image transfer
50 Activation means
60 Linear speed detection device
65 Control board
70 Alarm

### DETAILED DESCRIPTION OF THE EMBODIMENTS

The modern train moves along a set of parallel railroad tracks with a locomotive and a series of cars attached to the locomotive. Beneath the tracks are a plurality of the railroad ties that rest perpendicular to the railroad tracks and support the railroad tracks. This system of train travel has existed from the beginning of train travel. Because trains are typically loud and tend to travel throughout the night, trains often move in very remote locations.

Because trains are large cumbersome structures it is important to be able to periodically inspect the connections between cars as well as the general condition of the undercarriage of the train. The train cars are typically assembled using a set of knuckles and hasps that connect the cars. With this type of system the cars can be disconnected if desired. It is imperative that the integrity of the connections means (knuckles and hasps) and the train's undercarriage be inspected periodically. The failure of the connection means may lead to the derailment of a train with its attendant costs.

In the prior art the train would need to be stopped in order to allow humans to visually inspect the undercarriage for defects. This is cumbersome and results in delays in train travel and moving goods and people from location to location.

This system incorporates a series of items that will allow the undercarriage of a train to be inspected periodically without the need to stop the train for a visual inspection. A container 5 with the components of this device is secured to the ties 2 of a railroad track 1 and is designed to be portable; the container 5 may also be buried. The train will roll over the railroad tracks 1, which are perpendicular to the ties 2. As the trains move over the container a series of high resolution photographs are taken of the train's undercarriage.

The system is activated using a predetermined means 50 in the software that will detect the presence of a train. The system will remain active as long as it is required to capture the images and the system will automatically turn the system “off” using a preset in the software 40 for that purpose. During the normal operation is system is not operational until the presence of a train is detected by the activation means 50. The presence of a train may be detected using a laser system that will detect the presence of a train.

Within the container are the following components: camera 10, mirror 15, lighting means 20, a slit 30, which is in the range of 1-5 pixels wide and is provided so that the images of the undercarriage of a train car can be gathered. The camera images will be collected through the slit as the image of the undercarriage is reflected off the mirror 15 that is in the container 5. In order to insure a clear image, a piece of anti-glare glass 25 is placed over the slit 30 and the lighting around the area is carefully monitored and controlled.

The camera 10 is capable of capturing high resolution images at rapid speeds in a variety of lighting or environmental conditions to include low lighting, dim lighting, and complete darkness. Additionally the speed of the camera frame speed is controlled and adjusted in real time by the software from data that is collected from the linear speed detection device 60 and the control board 65 that collects the speed data and then adjusts the frame speed of the camera 10.

The mirror 15 is provided to insure that the image of the undercarriage of the train car is clearly represented and to prevent damage to the camera within the container. As the trains roll over the device on the tracks, a series of fragmented images are taken of the undercarriage of the train. These images are in the range of 1-5 pixels, with a preferential pixel width of 2 pixels. Each of the images are collected individually and sent to a server. The individual images that are captured are then reassembled to present a clear picture of the train undercarriage.

At a certain preset, probably the length of a train car, in the software control the set points at which images are reassembled into a picture of the individual train car. The individual train cars can then be reassembled by the software into a complete train and the images transferred 45. The software 40 is likely to have a preset at the individual train car so that the pixels can be reassembled into an individual train car and the view of the entire train once reassembled by the software can then be transferred to a remote location and then reassembled and viewed. The software will allow the images of the entire train to be forwarded to a remote location, if needed.

The lighting means 20 can be adjusted both in terms of intensity and direction to obtain the best possible images as the area above the slit 30 is illuminated. The lighting means is necessary to insure an appropriate discernible image can be captured and reproduced. The lighting means 20 is illuminated in such a way that it minimizes the likelihood of shadows covering the inspected areas of the trains undercarriage. Many different types of lighting means may be used but considerations for the lighting means should include the ability to quickly and brightly illuminate the area. The choice of LED lighting is probably an ideal means to illuminate although different means may be used.

Software 40 is provided to control the activation and deactivation of the system, the lighting means including the intensity and direction of the lighting means as well as the image capture and image transfer 45. After the fragmented pictures of the undercarriage of a train car are gathered, the images are reassembled to provide a high resolution image. End points are established by the software to gather a finite amount of information.

The software also provides an alarm 70 in the event that a preset anomaly is detected, such as a foreign object in the undercarriage of the train car or damage to any of the components of the undercarriage including the coupling or knuckle of the train car.

While the description of this invention is set forth in this application, modifications may be made to the invention without departing from the spirit of the invention.

The inventor claims:

1. An apparatus to capture continuous high resolution images of a moving train undercarriage that is comprised of:
a. a container;
wherein the container is a predetermined configuration;
wherein the container houses components;
said components include a camera, a mirror, illumination means,
anti-glare glass;
b. a linear speed detection device;
wherein the linear speed detection device measure the speed of the train;
c. a control board;
wherein a control board gathers the input from the linear speed detection device;
b. a camera;
wherein the camera is linked to the control board;
wherein the camera is capable of taking high resolution images;
wherein the camera will operate in a variety of lighting conditions;
wherein the frame rate of the camera can be modified;
c. a mirror;
wherein a mirror is provided to permit the gathering of the high resolution images;
wherein the mirror is positioned to permit the camera to take an image through a slit;
wherein the slit permits the capture of an image;
d. lighting means;
wherein the lighting means is provided in the container;
wherein said lighting means is adjustable;
wherein the direction of said lighting means can be changed;
wherein the intensity of the lighting means can be changed;
e. software;
wherein the software controls the activation and deactivation of the system;
wherein the software is provided to control the speed at which the camera captures images;
wherein the software controls the direction of the lighting;
wherein the software controls the intensity of the lighting;
wherein the software controls the frame rate of the camera;
f. an alarm;
wherein the alarm alerts personnel at a remote location using presets in the software;
e. anti-glare glass;
wherein the anti-glare glass helps to prevent light from entering the interior of the container;
wherein said anti-glare glass helps to prevent light from diminishing the quality of images captured by the camera.

2. The device as described in claim 1 wherein the camera is capable of capturing images in dim lighting.

3. The device as described in claim 1 wherein the camera is capable of capturing images in low lighting conditions.

4. The device as described in claim 1 wherein the camera is capturing images in darkness.

5. The device as described in claim 1 wherein the software captures a predetermined amount of images at a preset point.

6. The device as described in claim 1 wherein the slit is between 1-5 pixels in width.

7. The device as described in claim 1 wherein the system is activated using presets in the software.

8. The device as described in claim 1 wherein the system is deactivated using presets in the software.

9. A method to capture continuous high resolution images of an undercarriage of a train that is comprised of:
a. Determining the real time linear speed of the train with a plurality of linear speed devices;
b. Reporting the real time speed from the liner speed device to a remote control box;
c. Reporting the real time speed from the remote control box to a high resolution camera;
d. Using the reported real time speed of the train to capture a series of high definition images of the train's undercarriage;
e. Reporting the series of high definition images to the remote control box;
f. Reporting the series of high definition images from the remote control box to a remote location for viewing.
